(19) United States
(12) Patent Application Publication
(10) Pub. No.: US 2019/0202254 A1
(43) Pub. Date: Jul. 4, 2019

(54) Method for Producing a Leaf Spring, and Leaf Spring

(71) Applicant: SOGEFI HD SUSPENSIONS GERMANY GMBH, Hagen (DE)

(72) Inventors: Christian KRALER, Breckerfeld (DE); Frank KÖHLER, Hagen (DE); Ralf GROENING, Altena (DE)

(73) Assignee: Sogefi HD Suspensions Germany GmbH, Hagen (DE)

(21) Appl. No.: 16/325,356

(22) PCT Filed: Jan. 9, 2018
(86) PCT No.: PCT/EP2018/050430

§ 371 Date: Feb. 13, 2019

(30) Foreign Application Priority Data
Jan. 13, 2017 (DE) 10 2017 100 575.7

(51) Int. Cl. B60G 11/10; B21B 1/16; F16F 1/26; F16F 1/18

(52) U.S. Cl. CPC B60G 11/10; B21B 1/16; F16F 1/26; F16F 1/185; F16F 2226/04; F16F 2226/02; B60G 2206/428; F16F 2234/06; F16F 2238/022; B60G 2202/11; B60G 2206/724; B60G 2206/8109; B60G 2206/8106; F16F 2224/0208

(57) ABSTRACT

The present disclosure relates to a method for producing a leaf spring 1 for a vehicle axle suspension, wherein the at least one spring arm 5 bordering on a clamping portion 2 is formed from a rod-shaped preliminary material 7, 8 by a rolling process. By the rolling process for shaping the leaf spring a preliminary material rod 7, 8 having a rounded cross-sectional geometry is rolled out to produce a rectangular cross-sectional geometry in the clamping portion 2 and in the at least one spring arm 5, and thus the portion of the preliminary material rod 7, 8 provided for forming the clamping portion 2 in the finished leaf spring 1 is also reshaped by the rolling process and as a result a rolled structure is also formed therein.

### BACKGROUND

The present disclosure relates to a method for producing a leaf spring, in particular a leaf spring of which at least one spring arm has a non-constant cross-sectional area over its length, such as a parabolic spring, for a vehicle axle suspension, in which the at least one spring arm, which adjoins a clamping portion, is formed out of a bar-shaped base material by means of a rolling process. The present disclosure also relates to a leaf spring, in particular a leaf spring of which at least one spring arm has a non-constant cross-sectional area over its length, such as a parabolic spring, for a vehicle axle suspension, comprising a clamping portion formed by a first and a second contact surface and comprising at least one spring arm integrally formed thereon and formed by a rolling process.

Leaf springs are used, for example, in vehicle axle suspensions for cushioning shocks acting on the vehicle axle. Such a device may use single spring leaves or be held together by leaf spring assemblies composed of a plurality of individual spring leaves. Spring leaves having a cross-sectional area that remains constant over their length are usually used when leaf spring assemblies are composed as such. Parabolic springs have been developed in order to reduce the weight of leaf spring assemblies of this kind. These springs are leaf springs of which the spring arms integrally formed on the clamping portion are rolled out in the shape of a parabola, and in such a way that the parabolic spring has a constant stress distribution in the spring arms thereof. The cross-sectional area in the spring arms is non-constant in springs of this kind. This means that the cross-sectional area, usually the thickness of the parabolic spring in the spring arms thereof, changes in the manner of a parabola, and in particular reduces accordingly proceeding from the clamping portion in the direction of the end of the spring arm. The clamping portion is used to connect the leaf spring to the vehicle axle, usually using U-bolt plates which are fastened to a fifth-wheel plate of the axle by means of U-bolt screws, with the interposition of the clamping portion. Depending on the design of the vehicle suspension, a leaf spring of this kind may comprise one spring arm or two spring arms which are opposite one another with respect to the clamping portion. Fastening means by means of which the leaf spring is articulated on the chassis side are arranged at the ends of said arms if the leaf spring is also intended to perform guiding functions. The fastening means may for example be rolled-up eyes. The leaf thickness is constant in the region of the clamping portion, even in the case of a parabolic spring. The clamping portion is characterized by two mutually parallel contact surfaces. This is necessary for the connection on the axle side or in order to form a spring assembly.

Parabolic springs are produced from hot-rolled flat bars made of spring steel, usually according to the EN 10089 standard. Hot-rolled flat bars having a rectangular cross-sectional geometry are used, as are described in the EN 10092-1 standard. The flat bars described in this standard as base material bars for producing leaf springs can have semi-circular, semi-rounded or even straight short sides. In the latter case, the base material is characterized by rounded edges. All shapes can be included under the term “rectangular” used in the context of this design. This also includes shapes that deviate therefrom, so long as the base surface is rectangular or so as long as it has a planar upper face and a planar lower face extending in parallel therewith. Hot-rolled spring-steel flat bars of this kind are available in various thickness and widths.

In order to produce a parabolic spring, a base material bar is used of which the thickness corresponds to the thickness of the parabolic spring in its clamping portion. The portion intended as the clamping portion in a finished leaf spring, together with its contact surfaces provided by the upper face and the lower face, already serves as the clamping portion when producing the parabolic spring. In order to roll out the spring arms, the base material bar is clamped into a tool at the intended clamping portion so that the adjoining base material portions from which the spring arms are intended to be rolled out are movable relative to the roll stand(s). Reshaping is not required in the clamping region since the base material bar has been selected in the thickness intended for this purpose. A method of this kind for producing a parabolic spring is described in DE 10 2009 036 512 B3 and in DE 1 427 382 A1.

DE 103 56 312 A1 describes a device and a method for rolling a leaf spring as quickly as possible without having to process-anneal the same. This is achieved by a device which comprises a gripper, as a result of which the leaf spring blank can be automatically gripped and turned. The leaf spring blank is grasped by a clamping means in the region of its center or just outside the center.

Even if it has been possible to achieve significant weight reduction compared with leaf spring assemblies using a leaf spring designed as a parabolic spring, it would be desirable, in order to reduce the curb weight of a vehicle which requires leaf springs in its axle suspension, to be able to further reduce the weight of such a leaf spring. Moreover, when designing parabolic springs, it must be ensured that there is no fatigue failure. For this reason, the clamping portion has to have a certain thickness in order to avoid failure in the spring arm and also in the transition from the clamping portion into the spring arm.

### SUMMARY

Proceeding from the foregoing, an aspect of the present disclosure is to propose a method for producing a leaf spring for a vehicle axle suspension by means of which the leaf spring produced thereby, in particular when designed as a parabolic spring, can have a lower weight with the same spring performance.

Another embodiment of the present disclosure discloses, by means of the rolling process for forming the leaf spring, a base material bar having a rounded cross-sectional geometry that is rolled out into a rectangular cross-sectional geometry in the clamping portion and in the at least one spring arm, and therefore, by means of the rolling process, the base material bar portion intended for forming the clamping portion in the finished leaf spring is also reshaped and a rolled microstructure is also formed therein.

Another embodiment of the present disclosure discloses a leaf spring in which the clamping portion comprises a rolled microstructure of this kind made by the rolling process such that the reshaping rate and the associated grain elongation reduces towards the short sides.

The method of the present disclosure moves away from the prevailing teaching of not reshaping the clamping portion as the base material bar portion. On the contrary, the subsequent clamping portion consisting of the base material bar is also reshaped by a rolling process in order to form a rolled microstructure therein. The reshaping rate for forming the clamping portion out of the base material bar portion intended therefor is 15% or more. The reshaping rate can also easily be 25 to 30% or more. The higher the reshaping rate when rolling the base material bar portion intended for forming the clamping portion, the more intensive the formation of the rolled microstructure becomes. A rolled microstructure of this kind is characterized by a grain elongation or stretched microstructure. Rolling occurs when the base material bar is above its curing temperature, usually its austenitization temperature. Forming a rolled microstructure in the clamping portion as well means that this microstructure transitions continuously into the spring arm(s), in which the rolled microstructure is more pronounced than in the clamping portion on account of the correspondingly higher reshaping rate. Since the rolled microstructure continues into the clamping portion from the spring arms, which are dynamically moved when the parabolic spring is used, the notch sensitivity of the leaf spring is reduced in the transition between the at least one spring arm and the adjoining clamping portion. As a result, when realizing this concept, the thickness in the clamping portion can be reduced whilst having the same leaf spring performance compared with conventional and without having to consider failure, and therefore a weight reduction is justified. When rolling out the clamping portion, the above-described advantages already occur when the rolling is carried out without any tensile stress acting on the base material bar. An improvement in the formation of the rolled microstructure, which follows the longitudinal extension of the parabolic spring, can be achieved when the roll-out of the clamping portion is carried out under the effect of a tensile load acting on the base material bar and an associated defined elongation.

As a starting material for a leaf spring of this kind, a base material bar may have a rectangular or square cross-sectional geometry, or a rounded cross-sectional geometry.

In order to freeze the rolled microstructure of the rolled-out leaf spring and to prevent complete recrystallization, said spring is optionally also cooled (tempered) accordingly using intermediate heating steps following the rolling process, which can be carried out once or several times. This can take place by means of quenching, for example in an oil bath. Methods of this kind are well known. They also include so-called “ausforming”. In the tempering process, the formed leaf spring can be held in camber.

The above-described concept of also forming the clamping portion by rolling out a portion of the base material bar makes it possible to use a base material bar which does not necessarily have a planar upper face and a planar lower face extending in parallel therewith. Therefore, in order to produce a leaf spring—which does not necessarily have to be a parabolic spring—base material bars having a cross-sectional geometry that differs from the conventional rectangular cross-sectional geometry can also be used, for example rounded base material bars or even base material bars having a circular cross-sectional geometry. When using a base material bar having such a cross section, the reshaping rate for forming the clamping portion is usually approximately 25-30%, or is even higher than that. The reshaping rate in the base material bar portion that is intended to form the clamping portion also depends on how wide the opposing contact surfaces are intended to be. When using a base material bar having a rounded, in particular circular cross-sectional geometry, the reshaping rate and thus the formation of a rolled microstructure is at its greatest in the region of the center extending in the longitudinal extension of the leaf spring. The reshaping rate reduces somewhat towards the short sides, as does the grain elongation associated therewith. The lateral load capacity is nevertheless increased by the grain elongation also in the direction lateral to the longitudinal extension of the leaf spring since the notch sensitivity is reduced compared with a greater grain elongation on account of the smaller grain elongation at the short sides. Proceeding from a base material bar having a cylindrical lateral surface, a reshaping rate in the region of the clamping portion of approximately 30% is considered to be sufficient for obtaining contact surfaces that are of satisfactory width.

When rolling a parabolic spring out of a base material bar of this kind, the rolling process is usually carried out such that the higher reshaping rate in the spring arm(s) leads to a greater width of the spring arms compared with the clamping portion. The clamping portion is therefore narrower than the spring arm(s) integrally formed thereon. This also provides a weight reduction compared with known parabolic springs. Conventional parabolic springs have a clamping portion which is not reduced compared with the width of the parabolic spring in the spring arm(s). Instead of the previously described paring, in principle another form of mechanical working without geometrically defined cuts is possible.

When using base material bars having a rounded, in particular circular, cross-sectional geometry, a base material bar having a surface that can be mechanically worked at a reasonable cost can be used as the starting product for producing a leaf spring. The mechanical working of the surface of the base material bar is used to remove a surface decarburization layer, incomplete surface regions, scale and the like, i.e. surface defects which are not intended to be rolled into or otherwise remain a part of the surfaces of the leaf spring. It is known that, when producing helical springs and other rotationally symmetric spring elements (torsion bars, stabilizers), the performance of the springs produced thereby and thus also the weight thereof can be significantly reduced if the decarburization layer and other surface inadequacies have been removed before forming the spring. Helical compression springs have long been produced from rounded base material. This has hitherto not been possible for leaf springs in a reasonable manner, however. DE 1 281 468 A describes that rectangular base material bars are ground at the side in tension before the blank is heated and rolled in order to produce leaf springs. This is disadvantageous in that the proposed surface treatment takes place only on the side in tension. This method is also uneconomical and can lead to cracking due to abrasive martensite. When using a base material bar having a rounded, in particular circular cross-sectional geometry, as is proposed according to the present disclosure for producing leaf springs, an extensive surface-removal can be economically undertaken. For example, mechanically working the base material bar with a defined cut or cuts is useful in this respect and is also known as paring. Such mechanical working allows a surface layer that is approximately 0.5 to approximately 1.0 mm thick to be removed. Removing the surface layer before heating and rolling out the spring makes it possible to significantly enhance the performance of the produced springs. In other words: the same performance of a leaf spring can be achieved at a significantly lower weight. This also justifies a weight reduction.

Even if a rolled microstructure may be present in the clamping portion in this embodiment of the present disclosure, this embodiment also offers significant advantages compared with conventional leaf springs without having a rolled microstructure in the clamping portion. The spring can also be tempered in a subsequent step involving re-heating, usually when the leaf spring is in pre-camber.

The present disclosure is described in the following on the basis of an embodiment, with reference to the attached drawings, in which:

### BRIEF DESCRIPTION OF THE DRAWINGS

FIG. 1 schematically shows a parabolic spring comprising a clamping portion and a spring arm integrally formed thereon,

FIG. 2 shows a parabolic spring according to a further embodiment comprising two spring arms integrally formed on its clamping portion,

FIG. 3a, 3b schematically shows the cross-sectional variation when producing the parabolic spring from FIG. 1 proceeding from a hot-rolled base material bar into various portions of the parabolic spring (FIG. 3a), and shows a plan view depicting the change in width (FIG. 3b),

FIG. 4: is a schematic representation of an image of a microstructure of a base material bar in a normalized state, and

FIG. 5: is a schematic representation of a microstructure from the clamping portion of the parabolic spring from FIG. 1 with a sectional plane in the longitudinal extension of the parabolic spring.

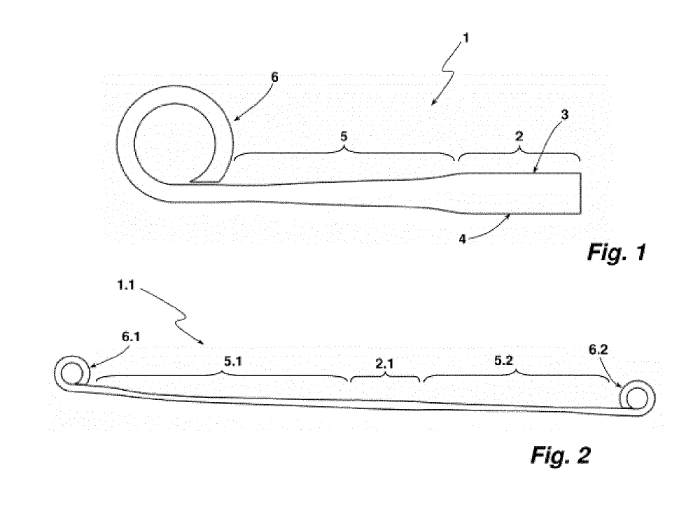

### DETAILED DESCRIPTION

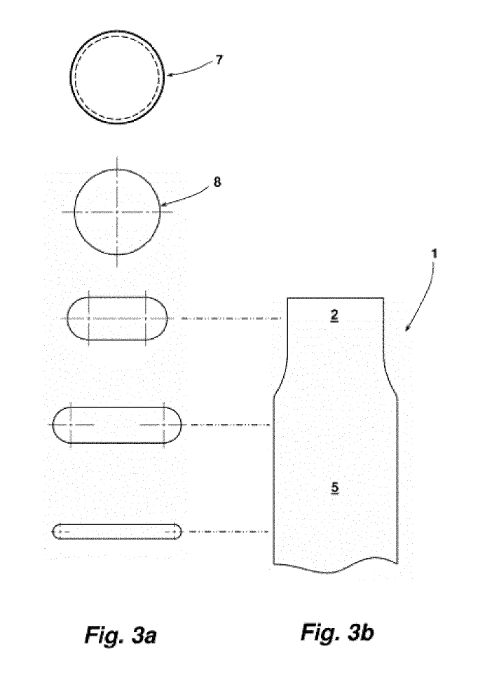

A parabolic spring 1 includes a clamping portion 2 comprising an upper contact surface 3 and a lower contact surface 4. The clamping portion 2 is used to connect the parabolic spring 1 to the axle of a vehicle. The connection to the axle takes place as is known for conventional parabolic springs, and therefore does not have to be described in more detail at this stage. A spring arm 5 is integrally formed on the clamping portion 2, the end of which arm is formed so as to provide a fastening means for connecting the parabolic spring 1 to the chassis of a vehicle at an eye 6. The parabolic spring 1 is formed by way of a rolling process, as will be explained in the following with respect to FIGS. 3a and 3b. The spring arm 5 is rolled out in the shape of a parabola and therefore has a cross-sectional area that reduces successively proceeding from its clamping portion 2 in the direction of the eye 6.

FIG. 2 shows a further parabolic spring 1.1, on the clamping portion 2.1 of which two spring arms 5.1, 5.2 are integrally formed. The two springs arms 5.1, 5.2 have an eye 6.1, 6.2 at their ends. In the parabolic spring 1.1, the clamping portion 2.1 is eccentric. This is due to the specific design of the parabolic spring 1.1.

The production method for producing the leaf spring 1 is described in more detail in the following. The leaf spring 1.1 is produced in the same manner.

The starting product for producing the parabolic spring 1 is a base material bar 7 having a rounded cross-sectional geometry. The base material bar is a hot-rolled bar, such as are known, made of spring steel.

In a first step, the surface layer is removed from the base material bar 7 by mechanical working, and in particular by a paring process known per se for the described embodiment. In the embodiment shown, a surface layer of approximately 0.8 mm is removed from the base material bar 7. The thickness of the surface layer to be removed is indicated by dashed lines on the base material bar in FIG. 3a. The base material bar 7 that has been freed of its surface layer is denoted in FIG. 3a by reference sign 8. Removing the surface layer means that surface defects are removed, for example a decarburization layer, scale, surface imperfections and the like. The cylindrical lateral surface of the base material bar 8 then has a significantly improved surface for the subsequent rolling process. In any case, hitherto existing surface inadequacies are not rolled into the leaf spring and do not remain part thereof.

In a subsequent step, the base material bar 8 is heated to its curing temperature. In the embodiment shown, the base material bar 8 is heated to its austenitization temperature. The base material bar 8, at its curing temperature, is subsequently rolled once or several times, in particular in order to form its clamping portion 2 and to form its spring arm 5. FIG. 3a shows the cross-sectional geometries of the parabolic spring 1 from the region of the clamping portion 2, the spring arm 5 and the roll-out end, which is also part of the spring arm 5. The position of the cross sections with respect to the parabolic spring 1 are shown with reference to FIG. 3b. The parabolic spring in FIG. 3 is shown to be reduced in length. The roll-out end is rolled so as to have a constant thickness. The eye 6 is formed therefrom in a subsequent step.

In order to avoid the rolling part cooling too much, it can be intermediately heated once or several times, in particular in those portions which have not yet been rolled out.

The rolling process is thus carried out at the same heat and subsequently tempered after the parabolic spring 1 has been formed. This means that the rolled microstructure formed during rolling is frozen, but recrystallization is prevented. The roll-out of the spring arm is carried out under the effect of a tensile load such that the roll-out is associated with an elongation of the base material bar 8. If specific short sides or edge formations are desired, it can be useful to set these by vertically rolling the short sides.

The plan view of the parabolic spring in FIG. 3b highlights the particular narrowing of the clamping portion 2 compared with the spring arm 5. It should be noted that this already justifies a weight reduction. On account of the narrowing in the region of the clamping portion 2 compared with the spring arm 5, only a narrower design of U-bolt plates and fifth-wheel plates is required to connect the parabolic spring 1 to a vehicle axle. This also leads to a weight reduction. Installation spaced is also saved. As such, parabolic springs of this kind, when arranged beside one another horizontally, are positioned closer to one another. The narrowing offers sufficient space in order to arrange a fifth-wheel plate and U-bolt screws therein.

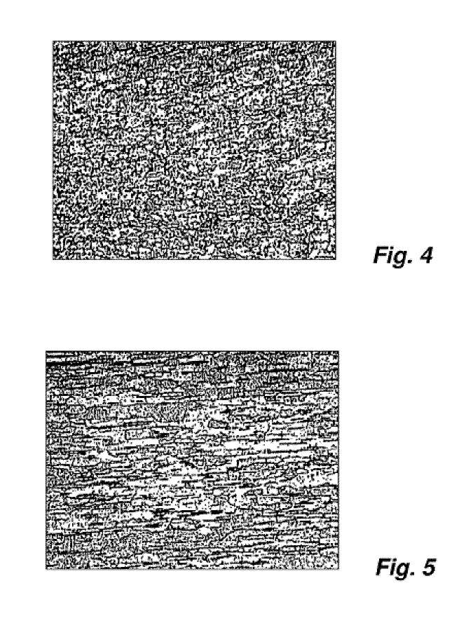

FIG. 4 is schematic representation of an image of the microstructure of the base material bar 8 with a sectional plane in the longitudinal extension thereof. The microstructure does not have a clear orientation. The grains have a largely symmetrical contour.

FIG. 5 is a schematic representation, by comparison, of an image of the microstructure from the clamping portion 2 of the parabolic spring 1, also with a sectional plane in the longitudinal extension of the parabolic spring 1. As a result of rolling out the clamping portion 2, as described above, the rolled microstructure shown in FIG. 5 has been formed. The microstructure is stretched, which results from a grain elongation. This microstructure is responsible for the above-described positive mechanical properties of the subsequent tempered microstructure.

A parabolic spring comprising integrally formed eyes is shown by way of example in the drawings. The advantages of the present disclosure also result in the same way in the case of spring leaves which do not comprise fastening means, such as eyes. Therefore, in the case of a spring assembly, each layer can be produced using the concept according to this present disclosure.

The present disclosure has been described on the basis of embodiments. Without departing from the scope of the current claims, there are numerous other embodiments for a person skilled in the art to be able to implement the present disclosure without further details regarding these embodiments having to be provided.

### LIST OF REFERENCE SIGNS

1, 1.1 Parabolic spring
2, 2.1 Clamping portion
3 Upper contact surface
4 Lower contact surface
5, 5.1, 5.2 Spring arm
6, 6.1, 6.2 Eye
7 Base material bar
8 Pared base material bar

1-17. (canceled)

18. A method for producing a leaf spring of a vehicle axle suspension comprising:
at least one spring arm, which adjoins a clamping portion and is formed out of a bar-shaped base material by means of a rolling process,
wherein, the rolling process for forming the leaf spring comprises a base material bar having a rounded cross-sectional geometry that is rolled out into a rectangular cross-sectional geometry in the clamping portion and in the at least one spring arm,
wherein, the base material bar of the rolling process for forming the clamping portion in the leaf spring is reshaped and a rolled microstructure is also formed therein,
a surface layer is mechanically removed from the base material bar before the base material bar for forming the leaf spring of the rolling process is rolled out, and
the rolling out of the at least one spring arm is carried out in a direction from the clamping portion to its other end in such a way that the cross-sectional area is reduced in at least one portion of the spring arm.

19. The method of claim 18, wherein the rolling out of the clamping portion of the leaf spring is carried out with a reshaping rate of 15% or more.

20. The method of claim 18, wherein the cross-sectional geometry of the base material bar is circular.

21. The method of claim 18, wherein the base material bar for forming the clamping portion is reshaped by more than 25 to 30%.

22. The method of claim 18, wherein the circular cross-sectional geometry of the base material bar is created by removing the surface layer.

23. The method of claim 22, wherein the surface layer is carried out by mechanically working the base material bar with a defined cut.

24. The method of claim 18, wherein the rolling process is carried out several times.

25. The method of claim 18, wherein a leaf spring comprising two spring arms is produced.

26. The method of claim 18, wherein the base material bar is rolled out of spring steel and is heated to curing temperature after a surface layer has been removed and before the rolling process, and
the rolling process is carried out at the same curing temperature and a formed leaf spring is subsequently cooled in order to freeze the rolled microstructure.

27. The method of claim 18, wherein the rolling out of the spring arm is carried out under an effect of a tensile load acting on the base material bar and an associated elongation.

28. A leaf spring of a vehicle axle suspension, comprising:
a clamping portion formed by a first and a second contact surface and comprising at least one spring arm integrally formed thereon and formed by a rolling process,
wherein the clamping portion comprises a rolled microstructure formed by the rolling process, and
a reshaping rate and associated grain elongation reduces towards the short sides, the at least one spring arm being rolled out to form a parabolic spring.

29. The leaf spring of claim 28, wherein the clamping portion has a smaller width than the at least one spring arm integrally formed thereon.

30. The leaf spring of claim 18, wherein a fastening element is formed at the end of the at least one spring arm that is opposite the clamping portion.

31. The leaf spring of claim 18, wherein the leaf spring comprises two spring arms.
